(19) United States
(12) Patent Application Publication
(10) Pub. No.: US 2014/0075463 A1
(43) Pub. Date: Mar. 13, 2014

(54) VOLUME BASED, TELEVISION RELATED ADVERTISEMENT TARGETING

(71) Applicant: Gaurav KAMDAR, Bangalore (IN)

(72) Inventor: Gaurav KAMDAR, Bangalore (IN)

(73) Assignee: Yahoo! Inc., Sunnyvale, CA (US)

(21) Appl. No.: 13/613,251

(22) Filed: Sep. 13, 2012

(51) Int. Cl. H04N 21/23

(52) U.S. Cl. 725/9; 725/32

(57) ABSTRACT

The present invention provides techniques that relate to television based advertising and advertisement targeting, such as advertisements presented via Internet TV, IPTV, and television programs streamed over the Internet. Techniques are provided that include monitoring user-initiated changes of volume during a television based advertisement. Based at least in part on such changes, a user's interest level in the advertisement may be assessed. Based at least in part on the assessed interest level, a second advertisement may be targeted to the user.

### BACKGROUND

Television programming, and advertisements such as commercials, have traditionally been a relatively passive and impersonal form of media. With the advent of the Internet, however, greater personalization and interaction has become possible, such as is the case with Internet TV and IPTV.

There is a need for techniques relating to television based advertising and advertisement targeting.

### SUMMARY

Some embodiments of the invention provide techniques that relate to television based advertising and advertisement targeting, such as advertisements presented via Internet TV, IPTV, and television programs streamed over the Internet. Some embodiments provide techniques that include monitoring user-initiated changes of volume during a television based advertisement. Based at least in part on such changes, a user's interest level in the advertisement may be assessed. Based at least in part on the assessed interest level, a second advertisement may be targeted to the user.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

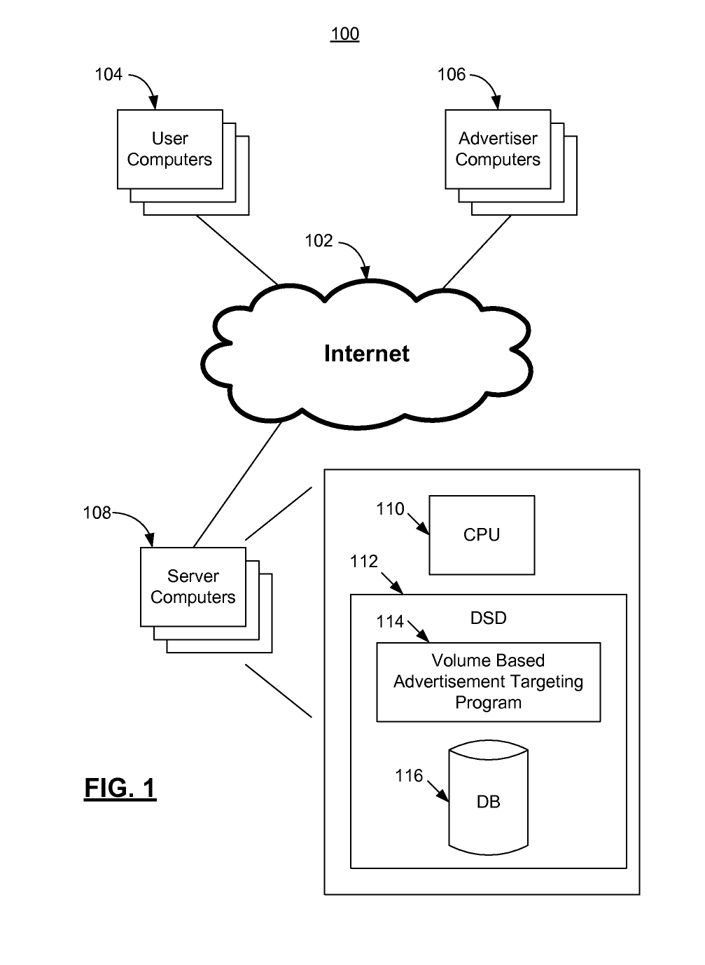

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, commercials, etc.

Some embodiments of the invention contemplate mobile uses and applications, such as use in connection with television based media on mobile devices or Internet capable devices such as smart phones, tablets, etc.

As depicted, each of the server computers 108 includes one or more CPUs 110 and a data storage device 112. The data storage device 112 includes a database 116 and a Volume Based, Television Related Advertisement targeting Program 114.

The Program 114 is intended to broadly include all programming, applications, algorithms, software, engines, modules, functions, and other tools necessary to implement or facilitate methods and systems according to embodiments of the invention. The elements of the Program 114 may exist on a single server computer or be distributed among multiple computers or devices.

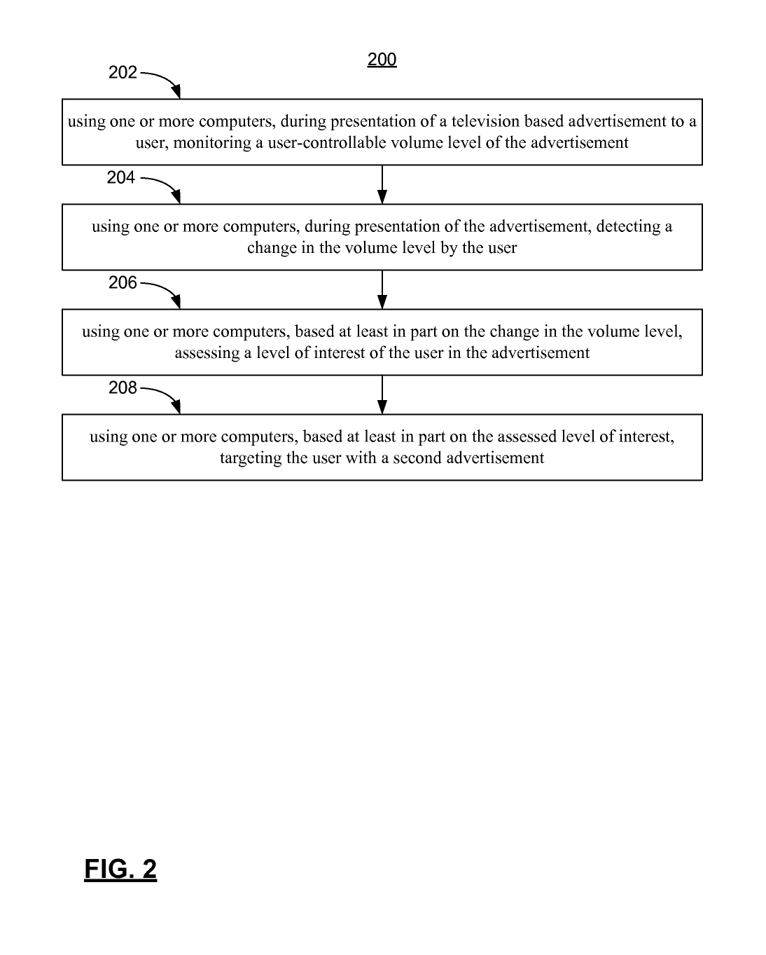

FIG. 2 is a flow diagram 200 illustrating a method according to one embodiment of the invention. Step 202 includes, using one or more computers, during presentation of a television based advertisement to a user, monitoring a user-controllable volume level of the advertisement.

Step 204 includes, using one or more computers, during presentation of the advertisement, detecting a change in the volume level by the user.

Step 206 includes, using one or more computers, based at least in part on the change in the volume level, assessing a level of interest of the user in the advertisement.

Step 208 includes, using one or more computers, based at least in part on the assessed level of interest, targeting the user with a second advertisement. Herein, “targeting” can broadly include selection, selection for serving to a particular user or under particular circumstances, optimization of selection, etc.

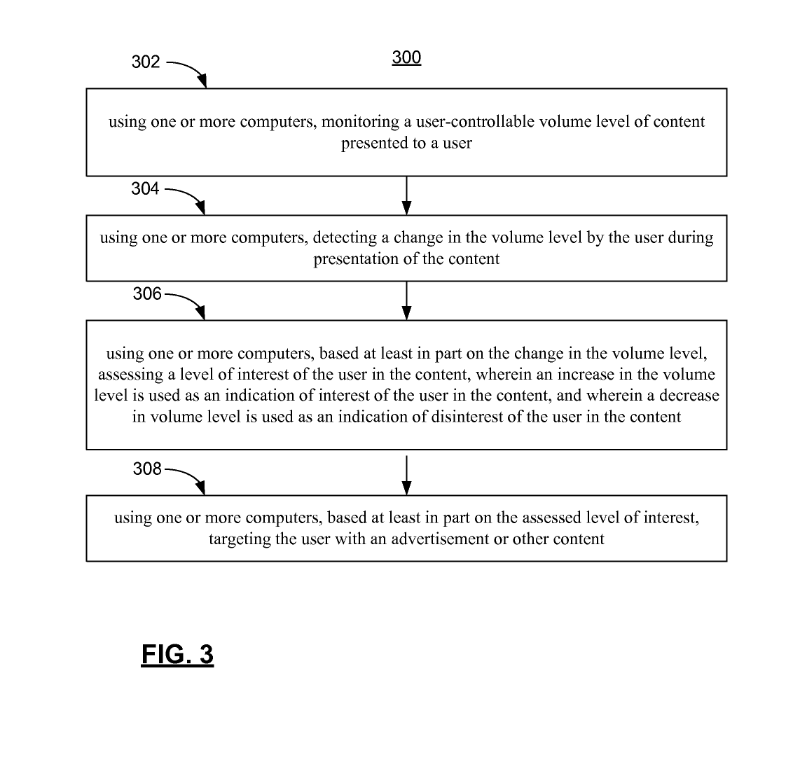

FIG. 3 is a flow diagram 300 illustrating a method according to one embodiment of the invention.

Step 302 includes, using one or more computers, monitoring a user-controllable volume level of content presented to a user.

Step 304 includes, using one or more computers, detecting a change in the volume level by the user during presentation of the content.

Step 306 includes, using one or more computers, based at least in part on the change in the volume level, assessing a level of interest of the user in the content, where an increase in the volume level is used as an indication of interest of the user in the content, and where a decrease in volume level is used as an indication of disinterest of the user in the content.

Step 308 includes, using one or more computers, based at least in part on the assessed level of interest, targeting the user with an advertisement or other content.

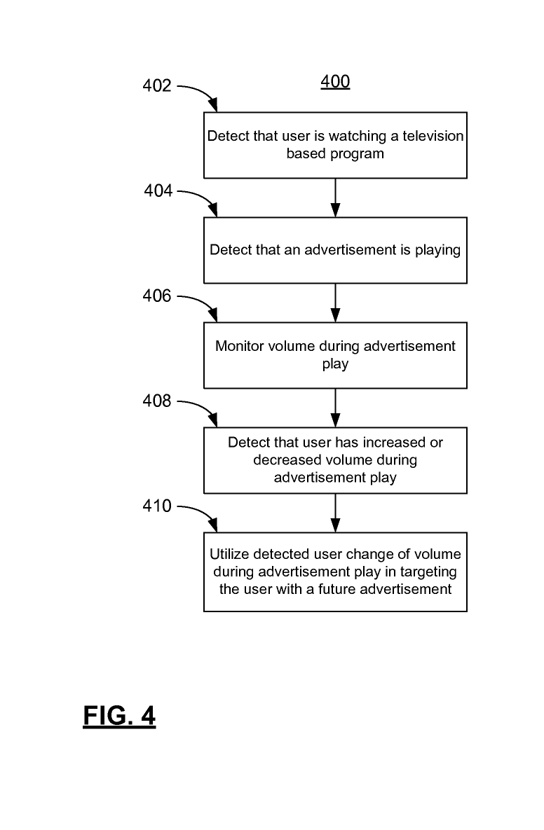

FIG. 4 is a block diagram 400 illustrating one embodiment of the invention.

Step 402 includes detecting that user is watching a television based program.

Step 404 includes detecting that an advertisement is playing.

Step 406 includes monitoring volume during advertisement play.

Step 408 includes detecting that user has increased or decreased volume during advertisement play.

Step 410 includes utilizing the detected user change of volume during advertisement play in targeting the user with a future advertisement.

Although described largely with reference to television based content and advertising, it is to be understood that some embodiments of the invention include techniques that may or may not relate to television based content and advertising. For example, some embodiments encompass any media content played or presented on a device where audio volume can be controlled, toggled, or otherwise affected by the user and detected, and may therefore be used as an indicator of interest, etc. As a further example, some embodiments relate to content that may be stored, such on a hard disk or memory, of a phone or other mobile device, where the content has an audio component (even if audio may be turned off or muted). Furthermore, in some embodiments, volume information may be collected from as many sources as possible and stored on the backend. For example, then, the next time the user comes online or is available, which could be a non-logged in user or a logged-in user, the stored information is used in targeting or serving optimized or more relevant advertisements. It is to be noted that a user need not necessarily be online during detection of volume change, targeting of additional advertisements, etc., yet information can be stored, even locally, and eventually collected on the backend, and then advertisements can be targeted and served to the user, even if the actual presentation of the advertisement occurs when the user is offline, such as if the advertisements are first stored locally, etc.

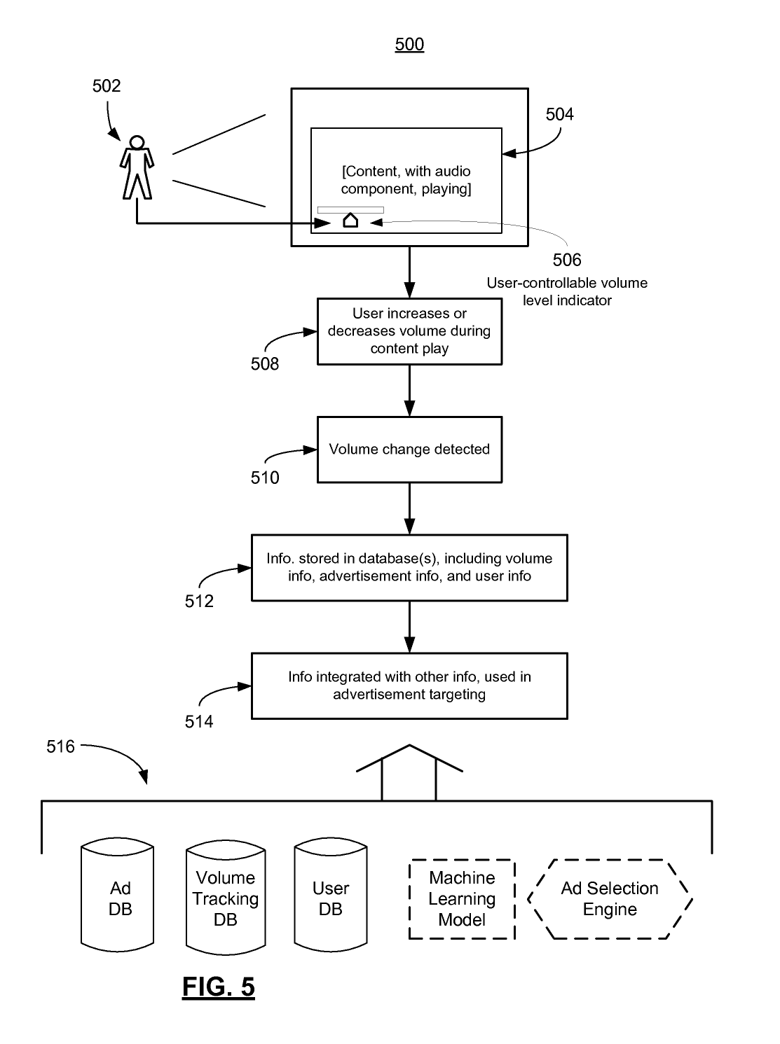

FIG. 5 is a block diagram 500 illustrating one embodiment of the invention.

A user 502 is depicted viewing and listening to a television program, which may be, for example, an Internet TV program, an IPTV program, or a television based Internet-streamed or otherwise presented or downloaded video, etc. As depicted, an advertisement 504, such as a commercial, is playing.

A volume indicator 506 is depicted, including a pointer that indicates the current volume level. The volume level is controllable by the user. For example, as depicted, the user can change the volume, and may be able to mute or unmute the volume, by interacting in some way, such as to move a pointer left or right to decrease or increase the volume, or by a device or remote control, for example.

Block 508 represents the user increasing or decreasing the volume during play of content with an audio component (even if the audio component may be turned off or muted), such as, for example, a television based advertisement.

Block 510 represents remote detection of the volume change, such as utilizing information received over the Internet or other networks, computer systems, or computers, eventually to server computers.

Block 512 represents information stored in one or more databases, including volume and volume change related information, information about the content being played during the detected volume change, and information about the user who viewed the content and changed the volume or who is presumed to or is determined to be likely to be the user who has viewed the content and changed the volume.

Block 514 represents integration of the information collected at block 512 with other information, such as information about other volume changes, content, advertisements, users, etc. Block 512 also represents use of the information, and the integrated information, in advertisement targeting.

Block 516 represents a non-comprehensive group of elements of some embodiments of the invention. Depicted elements include advertisement database, a user database, a volume tracking database, one or more machine learning models, and a software-based advertisement selection engine.

The advertisement database may include collected information regarding a large number of advertisements or other content, information about the advertisements, and information associated with advertisements, such as advertisement performance or other downstream information. For example, the advertisement database may include information defining advertisements, or information about advertisements, such as tags, features, or characteristics associated with advertisements. The advertisement database may also include various information associated with advertisement performance, including information about what users where served particular advertisements, how the advertisements performed with regard to the particular users, etc. Of course, various other information may be included in the advertisement database or elsewhere, which may be used in advertisement targeting, including user characteristics, or other information.

The user database may contain various information about or associated with users, such as users who have been presented with advertisements, and their behavior, including with respect to volume, such as increasing or decreasing volume during advertisement play. Other user related information may include specific information about each user, such as collected or determined information about the user's characteristics, demographics, tags, past behavior, profiles, similarity to other users or user groups, etc.

The volume tracking database may include various information about or associated with tracking of user-controllable volume levels, particularly with regard to television based programs and advertisements, such as commercials, presented during such programs. For example, the volume tracking database can include specific information regarding a particular user who changes a volume level during an advertisement, such as by increasing volume, which may indicate user interest or that the user likes the advertisement, or decrease in volume, including muting, which may indicate that the user is not interested in, or does not like, the advertisement. Of course, other specifics may also be stored, such as volume levels before and after volume changes, before or after advertisements, or during other times for comparison value, timing of volume changes, frequency of volume changes, volume changes relative to a user's typical volume related behavior or profile(s), etc.

The machine learning model(s) may be used in some embodiments of the invention, such as when machine learning techniques are used in advertisement targeting. For example, in some embodiments, features of advertisements and features of users, as well as volume-related information, historical advertisement performance information, and other information, may be used as input into a machine learning model. The model may then be used in advertisement selection, optimization, etc.

The advertisement selection engine represents various elements, such as software and software module elements, which may be distributed among different computers, etc., which is used in advertisement selection, targeting, and optimization. In some embodiments, the advertisement selection engine utilizes and integrates volume tracking information in advertisement selection, targeting, and optimization.

Some embodiments of the invention utilize volume based user behavior monitoring in television advertisement selection and serving.

Some embodiments include a recognition that, while watching television, for example, the user may tend to lower, such as mute, or raise the volume in reflection of, for example, preference for or relevance of the advertisement which is being shown. In some embodiments, data in collected on the volume response to an advertisement. For example, lowering volume or mute response may mean that the user is not inclined towards an associated product or the product is not of interest to the user. For example, the system may “learn” this pattern and send back data to the core system which processes it, and then uses it in future advertisement selection, targeting and serving. This can, in turn, help effectively target users via Internet TV or IP TV, and learn users' preferences in a non-intrusive way. In some embodiments, tracking of volume represents a unique parameter that can be used in advertisement targeting.

Furthermore, some embodiments recognize that television based media has been relatively impersonal. Some embodiments of the invention present an automated and non-intrusive way to enable television based media to become more personalized, relevant, and engaging, increasing user participation and ultimately increasing monetization.

Although described primarily with regard to advertisements, some embodiments of the invention use volume tracking in other areas, such as program selection, etc.

In some embodiments, a series of steps may, for example, include the following. First, a user watches (which can include listening to) an advertisement, but it is not relevant to the user, so the user lowers the volume or chooses mute (whether by mouse or other selection device, remote or other device, voice control, etc.). The system may capture this user response and tag it to the advertisement, or content, a product, or a brand associated with the advertisement, for example. Following this, if the advertisement or a related advertisement might otherwise be targeted to the user, the system may, based in part on the collected information, not target the user with the advertisement or related advertisement, since the user has signaled disinterest. Of course, the opposite can happen as well, where a user increases volume during an advertisement, and this signal may be detected and interpreted to indicate user interest in the advertisement or its content, and the advertisement or a related advertisement may be more likely to be targeted to the user, or associated or similar users, in the future.

Some embodiments allow advertisements and their agents to obtain volume related information that can indicate or suggest how the advertisers' advertisements are being received and performing, and better determine advertisement content, targeting, marketing strategies, etc.

Some embodiments of the invention provide a way to elevate television based media experience to a higher level of user personalization, engagement, and relevance, leading to substantially higher monetization.

Some embodiments provide a strong yet non-intrusive signal to be used in understanding user preferences regarding television based media. For example, unlike user ratings, etc. (which can also be used in some embodiments), some embodiments obtain powerful and informative user feedback without the need to disrupt the user's experience in any way, or require anything other than natural behavior from the user, and indeed without the user even needing to be aware of the signaling.

While the invention is described with reference to the above drawings, the drawings are intended to be illustrative, and the invention contemplates other embodiments within the spirit of the invention.

1. A method comprising:
using one or more computers, during presentation of a television based advertisement to a user, monitoring a user-controllable volume level of the advertisement;
using one or more computers, during presentation of the advertisement, detecting a change in the volume level by the user;
using one or more computers, based at least in part on the change in the volume level, assessing a level of interest of the user in the advertisement; and
using one or more computers, based at least in part on the assessed level of interest, targeting the user with a second advertisement.

2. The method of claim 1, wherein the television advertisement is presented via Internet TV.

3. The method of claim 1, wherein the television advertisement is presented via IPTV.

4. The method of claim 1, wherein the television advertisement is presented during television programming presented over the Internet.

5. The method of claim 1, wherein the television advertisement is presented during television programming streamed as video over the Internet.

6. The method of claim 1, wherein the change in volume level is an increase, and wherein the increase is assessed to indicate that the user is more interested in the advertisement than if the increase had not occurred.

7. The method of claim 1, wherein the change in volume level is an increase, and wherein the increase is assessed to indicate that the user is more interested in the advertisement than if the increase had not occurred, and wherein the second advertisement is similar in one or more ways to the advertisement, and wherein it is assessed that, due at least in part to the similarity of the second advertisement to the advertisement, the user is more likely to be interested in the second advertisement than if the change in volume level had not occurred.

8. The method of claim 1, wherein the change in volume level is a decrease, and wherein the decrease is assessed to indicate that the user is less interested in the advertisement than if the decrease had not occurred.

9. The method of claim 1, wherein information regarding changes in volume level during presentation of multiple advertisements to a user is stored and used in targeting future advertisements to the user or to other users.

10. The method of claim 1, wherein information regarding changes in volume level during presentation of multiple advertisements to multiple users is stored and used in targeting future advertisements to users.

11. The method of claim 1, wherein information regarding changes in volume level during presentation of multiple advertisements to multiple users is stored and used in targeting future advertisements users, and comprising using advertisement features and machine learning in the targeting.

12. The method of claim 1, comprising serving the second advertisement to the user.

13. A system comprising:
one or more server computers coupled to a network; and
one or more databases coupled to the one or more server computers;
wherein the one or more server computers are for:
during presentation of a television based advertisement to a user, monitoring a user-controllable volume level of the advertisement;
during presentation of the advertisement, detecting a change in the volume level by the user;
based at least in part on the change in the volume level, assessing a level of interest of the user in the advertisement; and
based at least in part on the assessed level of interest, targeting the user with a second advertisement.

14. The system of claim 13, wherein at least one of the one or more server computers is coupled to the Internet.

15. The system of claim 13, wherein the television advertisement is presented via Internet TV.

16. The system of claim 13, wherein the television advertisement is presented via IPTV.

17. The system of claim 13, wherein the television advertisement is presented during television programming presented over the Internet.

18. The system of claim 13, wherein the television advertisement is presented during television programming streamed as video over the Internet.

19. The system of claim 13, wherein the change in volume level is an increase, and wherein the increase is assessed to indicate that the user is more interested in the advertisement than if the increase had not occurred.

20. A non-transitory computer readable medium or media containing instructions for executing a method comprising:
using one or more computers, monitoring a user-controllable volume level of content presented to a user;
using one or more computers, detecting a change in the volume level by the user during presentation of the content;
using one or more computers, based at least in part on the change in the volume level, assessing a level of interest of the user in the content, wherein an increase in the volume level is used as an indication of interest of the user in the content, and wherein a decrease in volume level is used as an indication of disinterest of the user in the content; and
using one or more computers, based at least in part on the assessed level of interest, targeting the user with an advertisement or other content.
